(19) United States
(12) Patent Application Publication
(10) Pub. No.: US 2009/0024666 A1
(43) Pub. Date: Jan. 22, 2009

(54) METHOD AND APPARATUS FOR GENERATING METADATA

(75) Inventors: Jin Wang, Shanghai (CN); Daqing Zhang, Shanghai (CN); Xiaowei Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/278,423

(22) PCT Filed: Jan. 25, 2007
(86) PCT No.: PCT/IB07/50247

§ 371 Date: Aug. 6, 2008

(30) Foreign Application Priority Data
Feb. 10, 2006 (CN) 200610007079.6

(51) Int. Cl. G06F 17/30

(52) U.S. Cl. 707/104.1; 707/E17.009

(57) ABSTRACT

The present invention discloses a method for generating metadata, said metadata being associated with a content, the method comprising the steps of obtaining the uncompressed digital signal of said content; determining the feature data of said uncompressed digital signal, said feature data being associated with the features that can be physiologically sensed in the analog signal that corresponds to said uncompressed digital signal; and creating metadata that are associated with the physiological emotion according to said feature data. Therefore, a user can directly obtain metadata reflecting the physiological emotion.

### FIELD OF THE INVENTION

The invention generally relates to a method and apparatus for generating metadata, in particular to a method and an apparatus for generating metadata of multimedia content.

### BACKGROUND OF THE INVENTION

With the development of modern communication techniques, people can acquire a lot of information at any time. It is a growing challenge for a user to find the interesting content of abundant information. Therefore, there is an urgent need for a means for obtaining information resources to conveniently obtain and store the information required by the user.

Metadata are “data that describe other data”. Metadata provide a standard and universal descriptive method and retrieval tool for various forms of digitized information units and resource collections; and metadata provide an integral tool and a link for a distributed information system that is organically formed by diversified digitized resources (such as a digital library).

Metadata can be used in the fields of validation and retrieval and are mainly dedicated to helping people to search and validate the desired resources. However, the currently available metadata are usually only limited to simple information such as author, title, subject, position, etc.

An important application of metadata is found in the multimedia recommendation system. Most of the present recommendation systems recommend a program based on the metadata that match the program and the user's preference. For example, TV-adviser and Personal TV have been developed to help the user find the relevant contents.

U.S. Pat. No. 6,785,429B1 (filed on Jul. 6, 1999; granted on Aug. 31, 2004; with the assignee of Panasonic Corporation of Japan) discloses a multimedia data retrieval method, comprising the steps of storing a plurality of compressed contents; inputting feature data via a client terminal; reading feature data extracted from the compressed contents and storing the feature data of the compressed contents; and selecting feature data approximate to the feature data input via the client terminal among the stored feature data, and retrieving a content having the selected feature data from the stored content. The feature data in the invention represent information about shape, color, brightness, movement and text, and these feature data are obtained from the compressed content and stored in the storage device.

### OBJECT AND SUMMARY OF THE INVENTION

Research has found that a user needs the metadata that can directly reflect the physiological emotion of the user, not just the metadata of some simple physical parameters. For example, the color atmosphere of a program and the rhythm atmosphere of the program are important factors for evaluating whether the program is interesting. If a user likes movies having rich and bright colors, whereas the system recommends a program that looks gray, the user will be disappointed. Besides, if a user likes movies of compact rhythm atmosphere, whereas the program recommended by the system has a slow rhythm atmosphere, the user will also be disappointed.

However, the current metadata standards or recommendation systems (e.g., DVB, TV-Anytime) mostly do not include such metadata that can directly reflect the physiological emotion of the user, thus directly lower the efficiency of the recommendation systems.

One object of the present invention is to provide a method for generating metadata that directly reflect the physiological emotion of a user.

This object of the present invention can be achieved by a method for generating metadata, said metadata being associated with a content. First, the uncompressed digital signal of said content is obtained; then the feature data of said uncompressed digital signal are determined, said feature data being associated with the features that can be physiologically sensed in the analog signal that corresponds to said uncompressed digital signal; finally, metadata that are associated with a physiological emotion are created in accordance with said feature data.

Another object of the present invention is to provide an apparatus for generating metadata which can directly reflect the physiological emotion of the user.

This object of the present invention can be achieved by an apparatus for generating metadata, said metadata being associated with a content. Said apparatus comprises an obtaining means for obtaining the uncompressed digital signal of said content; a determining means for determining the feature data of said uncompressed digital signal, said feature data being associated with the features that can be physiologically sensed in the analog signal that corresponds to said uncompressed digital signal; and a creating means for creating metadata that are associated with a physiological emotion according to said feature data.

Other objects and attainments of the invention, together with a more complete understanding of the invention will become apparent and appreciated by the following description taken in conjunction with the accompanying drawings and the claims.

### BRIEF DESCRIPTION OF THE DRAWINGS

FIG. 1 is a flowchart of the method for generating metadata reflecting the color atmosphere according to one embodiment of the present invention.

FIG. 2 is a flowchart of the method for generating metadata reflecting the rhythm atmosphere according to one embodiment of the present invention.

FIG. 3 is a schematic block diagram of the metadata generating apparatus according to one embodiment of the present invention.

Throughout the figures, the same reference numerals represent similar or the same features and functions.

### DETAILED DESCRIPTION OF THE INVENTION

The present invention provides a metadata generating method, said metadata being associated with a content. The content can be taken from or present in any information source such as a broadcast, a television station or the Internet. For example, the content may be a television program. The metadata are associated with the content and they are data describing said content. Said metadata can directly reflect the user's physiological emotion to said content, such as bright, gray, cheerful, relaxed, fast in rhythm, slow in rhythm, etc.

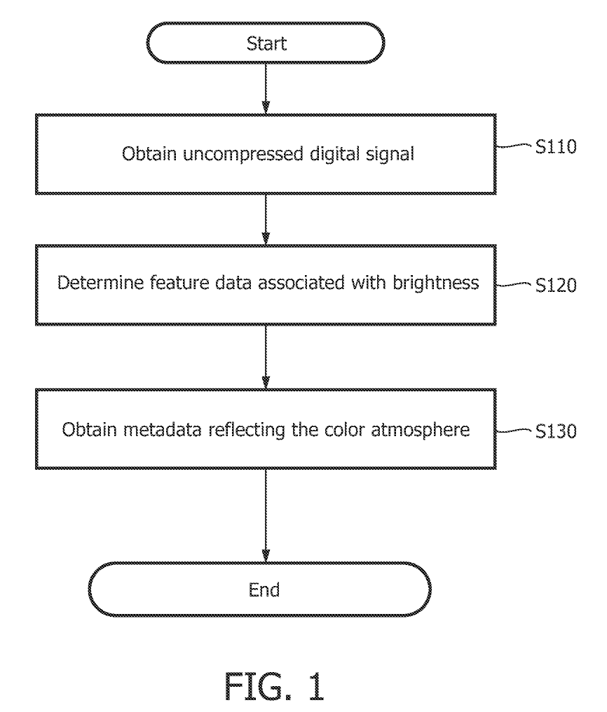

FIG. 1 is a flowchart of the method for generating metadata reflecting the color atmosphere according to one embodiment of the present invention.

First, the uncompressed digital signal of a content is obtained (step S110). The uncompressed digital signal means that the digital signal is not compressed, for example, the content is processed by said method when said content is made so as to generate the corresponding metadata; or the digital signal has been decompressed after being compressed, for example, the content is processed by said method when said content is played so as to generate the corresponding metadata. Obtaining the content can be realized either by reading the content pre-stored on the storage device, or storing uncompressed digital information.

The obtained uncompressed digital video signal can be information like the Yuv (luminance, chroma, chromatic aberration) value of each frame of image.

Then, the feature data of said uncompressed digital signal are determined (step S120), said feature data being associated with the luminance features that can be physiologically sensed in the analog signal that corresponds to said uncompressed digital signal. The features associated with the physiological features in video information include the luminance information that can be sensed by human eyes. The method of determining the feature data that can be sensed by human eyes of a certain image frame comprises a step of averaging the luminance value of all the pixels of a video image frame, thereby obtaining the feature data reflecting the luminance of said image frame. Since the determined uncompressed digital video signal can be a plurality of image frames, there can be a plurality of obtained feature data.

By experimenting on typical series, a pre-set value (luminance threshold) is obtained (Y1=85, Y2=170). If the average luminance value Y (feature data) of all the pixels of a frame is less than 85, said frame is labeled “dark”; if 85≦Y≦170, said frame is labeled “medium”; and if Y>170, it is labeled “bright”. For instance, when the average luminance value of all pixels of a frame is (125,−11, 11), said frame can be considered to have medium brightness.

If the metadata are generated on the user side, the pre-set value (e.g., luminance threshold) can be adjusted by the user, so that the generated metadata can reflect the personal preference of a specific user more accurately.

In order to better reflect the physiological emotion, experiments can be made to define the favorite skin colors (Y1=170, U1=−24, V1=29) and (Y2=85, U2=−24, V2=29), that is, if the average luminance value Y of the pixels is greater than Y1, the color is relatively bright, and if Y2≦Y≦Y1, the color is “medium”, otherwise, the color is dark.

Finally, metadata that are associated with the color atmosphere are created according to said feature data (step S130). Said step processes the above-mentioned feature data, compares them with the pre-set value, and finally obtains the metadata reflecting the color atmosphere. The color atmosphere is associated with the physiological emotion of a person. For example, metadata reflecting color atmosphere can be data reflecting whether the video content is bright or dark.

When most of the labeled image frames (e.g., ⅔ of the total number of image frames) are determined to be bright, then the metadata reflecting the color atmosphere of said content can be obtained as: bright color atmosphere. If most of the determined image frames are determined to be dark, then the metadata reflecting the color atmosphere of said content can be obtained as: dark color atmosphere. If most of the determined image frames are determined to be medium, then the metadata reflecting the color atmosphere of said content can be obtained as: medium color atmosphere.

Said method can further include a step of converting the uncompressed digital signal represented by a non-luminance parameter into the uncompressed digital signal represented by a luminance parameter. A video signal can be represented by RGB (the three primary colors of red, green and blue). If the uncompressed digital signal obtained in step S110 is represented by RGB color space, then in this step, all the video information represented by a non-luminance parameter should be converted into video information represented by luminance parameter, because the luminance of the video information represented by RGB varies with the change of the display device.

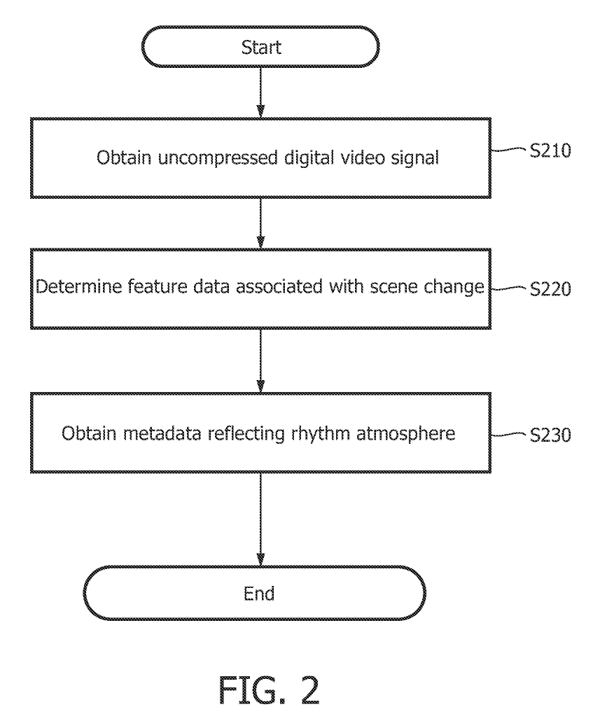

FIG. 2 is a flowchart of the method for generating metadata reflecting the rhythm atmosphere according to one embodiment of the present invention.

First, the uncompressed digital signal of said content is obtained (step S210). The uncompressed digital signal means that the digital signal is not compressed, for example, processing the content by said method when making said content so as to generate the corresponding metadata; or the digital signal has been decompressed after being compressed, for example, processing the content by said method when playing said content so as to generate the corresponding metadata. Obtaining the content can be realized either by reading the content pre-stored on the storage device, or by storing uncompressed digital information.

The uncompressed digital signal obtained in this embodiment is the luminance histogram in each video image frame. In the luminance histogram, the horizontal axis represents the range of the value of luminance from 0 to 25, and the vertical axis represents the number of pixels.

Next, the feature data of said uncompressed digital signal are determined (step S220), said feature data being associated with the scene change features that can be physiologically sensed in the analog signal that corresponds to said uncompressed digital signal.

The luminance histogram reflects the luminance distribution of pixels in the image frame, thus reflecting the luminance of the image frame. Suppose that the luminance histogram of the current frame is Hc, and the luminance histogram of the reference frame is HR, the reference frame is usually the frame previous to the current frame. The luminance difference d between said two frames is calculated by summing the absolute values of the differences between the luminance components, which is defined by the following formula:

$$d = {\sum }_{k = 0}^{255} \vert {H}_{c} ( k ) - {H}_{R} ( k ) \vert$$

If the value d is higher than a certain critical value T, the scene is considered to have changed. Thereby, the feature data reflecting the change of scene of two adjacent frames is obtained as: scene change. For example, with respect to an image having the size of 720×576, through experimenting with T=256×400=102400, when the luminance level K is 128, the histograms of gray scale of the previous frame and the subsequent frame are Hr (128)=700 and Hc (128)=1200, then |Hr (128)−Hc (128)|=500. Finally, if d>102400, then the scene of the current frame has changed.

Finally, metadata that are associated with the rhythm are created in accordance with said feature data (step S230). The speed of rhythm reflects the physiological emotion of a person. A counter is used to count the times of scene changes of the obtained uncompressed digital signal, thus counting the scene changes of all the obtained frames. If the number of frames having scene changes exceeds ⅔ of the total number of frames, the metadata associated with the physiological emotion are created as fast rhythm; if the number of frames having scene changes is less than ⅓ of the total number of frames, the metadata associated with the physiological emotion are created as slow rhythm; and if said number is in between the two of them, metadata are created as medium rhythm.

If metadata are generated on the user side, the pre-set value (T value) can be adjusted by the user, so that the generated metadata can reflect the personal preference of a specific user more accurately.

Said method may include a step of converting the uncompressed digital signal represented by a non-luminance parameter into the uncompressed digital signal represented by a luminance parameter. If the uncompressed digital signal obtained in the step S210 is represented by RGB color space (the three primary colors of red, green and blue), then in this step, all the video information represented by the non-luminance parameter should be converted into video information represented by the luminance parameter, because the luminance of the video information represented by RGB varies with the change of the display device.

In the method of generating metadata as provided by the present invention, the obtained uncompressed digital signal can also be part of an uncompressed digital signal of said content. For example, the information (e.g. the image frame corresponding to the I frame in the compressed domain) of the key image frame of the video signal can be read, or the uncompressed digital signal can be read according to a certain sampling frequency.

The metadata can be simply expressed as:

Metadata “0”- - - bright

Metadata “1”- - - medium

Metadata “2”- - - dark

Metadata “3”- - - fast

Metadata “4”- - - medium

Metadata “5”- - - slow

For complicated metadata, other descriptive languages such as HTML, XML are involved.

Apparently, according to the above-mentioned two embodiments, if the content is determined to be both bright and fast in rhythm, metadata can be created as: cheerful content; if the content is determined to be both bright and slow in rhythm, metadata can be created as: relaxed content. More metadata reflecting physiological emotion can be combined created by analogy.

Obviously, the feature data determined in the present invention can also be associated with the chroma and chromatic aberration that can be sensed by human eyes.

The present invention is obviously also suitable for audio digital signals. The steps thereof are as follows: first, the uncompressed digital audio signal of the content is obtained; then the feature data that can be physiologically sensed in the analog signal that corresponds to the digital signal are determined, for example, the determined feature data can be the sample value of the audio signal at a certain frequency, the sample value of the digital audio signal at a certain frequency depends on the sampling frequency and quantization precision, e.g. 24 kHz, 8 bits, then the range thereof is 0˜255; finally, metadata, such as loudness, tone, timbre, etc., associated with physiological emotion can be created by analyzing the statistical result of the sample values under a certain frequency. As for the metadata reflecting the audio rhythm atmosphere variation, experiments can be made to obtain the corresponding frequency threshold reflecting the speed of the music rhythm through statistics of the variations of the sample values of the frequency thereof, for example, the threshold is defined as f₀=531, if f>f₀, then the rhythm atmosphere is “fast”, otherwise, the rhythm atmosphere is “slow”.

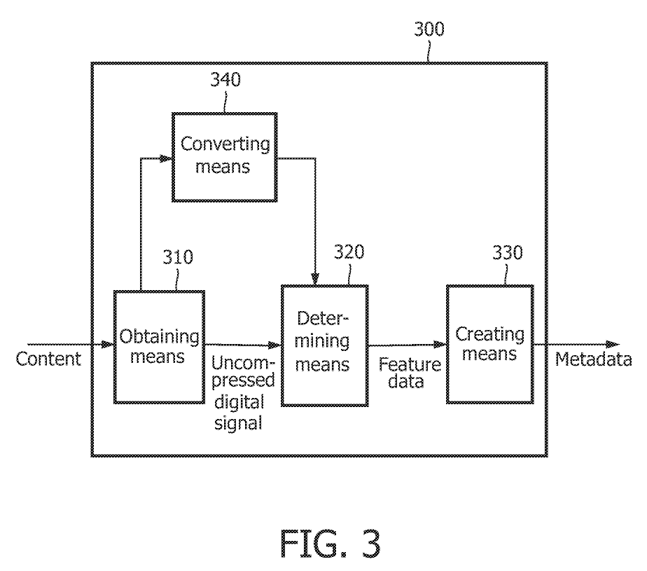

FIG. 3 is a schematic block diagram of the metadata generating apparatus according to one embodiment of the present invention.

The present invention also provides an apparatus for generating metadata, said metadata being associated with a content. The content can be taken from or be present in any information source such as a broadcast, a television station or the Internet, etc. For example, the content may be a television program. The metadata are associated with the content and they are data describing said content. Said metadata can directly reflect the user's physiological emotion to said content, such as bright, gray, fast in rhythm, slow in rhythm, cheerful, relaxed, etc.

An apparatus 300 comprises an obtaining means 310, a determining means 320 and a creating means 330.

The obtaining means 310 is used for obtaining the uncompressed digital signal of said content. The uncompressed digital signal means that the digital signal is not compressed, or the digital signal has been decompressed after being compressed. Obtaining the content can be realized either by reading the content pre-stored on the storage device, or storing the uncompressed digital information.

The obtaining means 310 can be a processor unit.

The determining means 320 is used for determining the feature data of said uncompressed signal, said feature data being associated with the features that can be physiologically sensed in the analog signal that corresponds to said uncompressed signal. The features associated with the physiological features in video information include the information of luminance, chroma, etc. that can be sensed by human eyes. For example, said feature data can be the average luminance information of a certain image frame of the uncompressed digital video signal. Said feature data can also be the scene change information in the video image frame.

The determining means 320 can be a processor unit.

The creating means 330 is used for creating metadata associated with physiological emotion in accordance with said feature data. The creating means is used for comparing the determined feature data with the pre-set value to finally obtain the metadata reflecting the physiological emotion. For example, metadata reflect whether the color atmosphere of the video content is bright or gray, or metadata reflect whether the content is cheerful or relaxed, and metadata reflect the volume of audio content, and whether the rhythm atmosphere is cheerful or relaxed, etc.

The creating means 330 can be a processor unit.

The apparatus 300 can also optionally comprise a converting means 340 for converting the uncompressed digital signal represented by non-brightness into the uncompressed digital signal represented by brightness. When the video signal is represented by RGB (the three primary colors of red, green and blue) color space, this converting means 340 is used for converting all the video information represented by a non-luminance parameter into video information represented by a luminance parameter, because the luminance of the video information represented by RGB varies with the change of the display device.

The present invention can also be implemented by means of a suitably programmed computer provided with a computer program for generating metadata, said metadata being associated with a content. Said computer program comprises codes for obtaining the uncompressed digital signal of said content, codes for determining the feature data of the uncompressed digital signal, said feature data being associated with the features that can be physiologically sensed in the analog signal that corresponds to said uncompressed digital signal, and codes for creating metadata associated with physiological emotion in accordance with said feature data. Such a computer program product can be stored on a storage carrier.

These program codes can be provided to a processor to produce a machine, so that the codes executed on said processor create means for implementing the above-mentioned functions.

In summary, by obtaining and processing the feature data of the uncompressed digital signal, the above embodiments of the present invention obtain metadata associated with physiological emotion and reflecting the content feature. Since the uncompressed digital data only suffer a small loss, the generated metadata can more accurately reflect the feature of the content.

Whereas the invention has been illustrated and described in detail in the drawings and foregoing descriptions, such illustration and description are to be considered illustrative or exemplary and not restrictive; the present invention is not limited to the disclosed embodiments.

Other variations to the disclosed embodiments can be understood and effected by those skilled in the art while carrying out the claimed invention, from a study of the drawing, the disclosure, and the appended claims. In the claims, the word “comprise” does not exclude other elements or steps, and the indefinite article “a” or “an” does not exclude “a plurality of”. A single processor or other unit may perform the functions of several items recited in the description. Any reference sign in the claims shall not be construed as limiting the scope.

1. A method for generating metadata, said metadata being associated with a content and comprising the steps of:
obtaining (S110) the uncompressed digital signal of said content;
determining (S120) the feature data of said uncompressed digital signal, said feature data being associated with the features that can be physiologically sensed in the analog signal that corresponds to said uncompressed digital signal; and
creating (S130) metadata that are associated with a physiological emotion in accordance with said feature data.

2. The method as claimed in claim 1, wherein said content is a video signal.

3. The method as claimed in claim 2, wherein said feature data are data of the average luminance information, average chroma information and scene change information.

4. The method as claimed in claim 2, wherein the uncompressed digital signal obtained in said obtaining step (S110) is represented by a non-luminance parameter, the method further comprising the step of converting the uncompressed digital signal represented by a non-luminance parameter into the uncompressed digital signal represented by a luminance parameter.

5. The method as claimed in claim 1, wherein said content is an audio signal.

6. The method as claimed in claim 5, wherein said feature data are sample values of a certain frequency and a specific frequency.

7. The method as claimed in claim 1, wherein the metadata associated with the physiological emotion comprise brightness, or gray, fast rhythm, slow rhythm, cheerfulness or relaxation.

8. The method as claimed in claim 1, wherein said uncompressed digital signal is part of an uncompressed digital signal having said content.

9. An apparatus for generating metadata, said metadata being associated with a content, the apparatus comprising:
an obtaining means (210) for obtaining the uncompressed digital signal of said content;
a determining means (220) for determining the feature data of said uncompressed digital signal, said feature data being associated with the features that can be physiologically sensed in the analog signal that corresponds to said uncompressed digital signal; and
a creating means (230) for creating metadata that are associated with a physiological emotion according to said feature data.

10. The apparatus as claimed in claim 9, wherein said content is a video signal.

11. The apparatus as claimed in claim 10, wherein said feature data are data of the average luminance information, average chroma information and scene change information.

12. The apparatus as claimed in claim 10, wherein the uncompressed digital signal obtained by said obtaining means (210) is represented by a non-luminance parameter, the apparatus further comprising a converting means for converting the uncompressed digital signal represented by a non-luminance parameter into the uncompressed digital signal represented by a luminance parameter.

13. The apparatus as claimed in claim 9, wherein said content is an audio signal.

14. The apparatus as claimed in claim 13, wherein said feature data are the sample value of a certain frequency and a specific frequency.

15. The apparatus as claimed in claim 9, wherein the metadata associated with the physiological emotion comprise brightness, or gray, fast rhythm, slow rhythm, cheerfulness or relaxation.

16. The apparatus as claimed in claim 9, wherein said uncompressed digital signal is part of an uncompressed digital signal having said content.

17. A computer program product for generating metadata, said metadata being associated with a content, the computer program product comprising:
codes for obtaining the uncompressed digital signal of said content;
codes for determining the feature data of the uncompressed digital signal, said feature data being associated with the features that can be physiologically sensed in the analog signal that corresponds to said uncompressed digital signal; and
codes for creating metadata associated with a physiological emotion according to said feature data.
